(19) United States
(12) Patent Application Publication
(10) Pub. No.: US 2015/0067880 A1
(43) Pub. Date: Mar. 5, 2015

(54) LOCATION SPOOFING FOR PRIVACY AND SECURITY

(71) Applicant: Location Sentry Corp., Camas, WA (US)

(72) Inventors: Matthew L. WARD, Collegeville, PA (US); Craig E. SPIEGELBERG, Washougal, WA (US)

(21) Appl. No.: 14/474,049

(22) Filed: Aug. 29, 2014

Related U.S. Application Data
(60) Provisional application No. 61/959,703, filed on Aug. 31, 2013.

(51) Int. Cl. H04W 12/02; G06F 21/60; H04W 4/02

(52) U.S. Cl. CPC H04W 12/02; H04W 4/02; G06F 21/60
USPC 726/26

(57) ABSTRACT

A sentry system is provided for use within a mobile device to limit access to device location using onboard systems. Access limitation can include access to only spoofed data in accordance to the rules or user instructions. Spoofed data may include refinements to render a location estimate and associated collateral information to be more plausible.

### CROSS REFERENCE AND RELATED APPLICATIONS

This application claims priority under 35 USC 119 from U.S. Provisional Application Ser. No. 61/959,703 filed on Aug. 31, 2013, titled LOCATION SPOOFING PRIVACY AND SECURITY by WARD, Matthew L., the entire disclosure of which is incorporated herein by reference.

### FIELD OF THE INVENTION

The invention relates to methods and apparatus for information management associated with a wireless device and, more specifically, but not exclusively, to use of the wireless device to generating spoof information regarding location of the wireless device.

### BACKGROUND OF THE INVENTION

With the explosive growth in mobile devices, wireless data rates and mobile-based software applications, the security and privacy needs of the user of wireless devices such as smartphones, tablet computers, and wireless LAN-equipped netbooks, laptop portable computers or voice-over-IP phones with nomadic capabilities, has largely been ignored.

In the rush to establish/gain market share, device manufacturers modified existing operating systems (e.g. UNIX, LINUX, Microsoft Windows, QNX, POSIX, NeXT, BSD) and added hardware subsystems and sensors (e.g. cameras, accelerometers, GPS receivers, infrared transceivers, Wi-Fi transceivers, Bluetooth transceivers, and digital signal processors) without due consideration to the unique security and privacy situation of a device as private and personal as a wireless device.

The existing security models of the operating systems were designed to preserve system integrity and data integrity but not designed with the mobility and network access inherent in wireless devices in mind. As such the existing separation of the operating system for user-level applications and the sandboxing of application from each other do not prevent leakage of private information from the wireless device. The present OS security model provides ample opportunity for the infiltration of mal-ware and virus-like applications. Also, the OS security model provides no protection against commercial leakage of private data by carriers, App providers, Operating System makers or OEMs intent on selling or using customer private data; or infiltration of malware at the OS maker, carrier, or OEM levels.

Even “anonymous” location data with no Personally Identifiable Information (PII) included is not enough to ensure user privacy. Researchers at the Massachusetts Institute of Technology (MIT) and the Catholic University of Louvain studied 15 months' worth of anonymized mobile phone records for 1.5 million individuals. They found from the “mobility traces”—the evident paths of each mobile phone—that only four locations and times were enough to identify a particular user 95% of the time.

As can be seen, the simplistic, all-or nothing security settings of wireless devices and the narrow legislation that provides penalties for only the most egregious offenders (if the identity of the offender can ever be discovered), are a poor substitute for active user control of the formation and dissemination of personal information. For example, the “Location Privacy Protection Act of 2011” (Senate bill. 1223) was a narrowly-tailored location-only bill that would require any company that may obtain a customer's location information via smartphone or other mobile device to get that customer's express consent before obtaining and sharing, selling or renting location data. The bill also would create focused criminal penalties for the worst abusers of location technology, including the knowing and intentional use of so-called “stalking apps” to violate federal anti-stalking and domestic violence laws. Therefore, what is needed is a system and method for location masking that is undetectable to the location recipient.

### SUMMARY OF THE INVENTION

A system and method are provided that allow location masking that cannot be detected by the recipient. The inventive techniques and concepts described herein apply to operating systems such as, and including; Android, iOS, Windows Mobile, Blackberry, Symbian, PalmOS, Firefox OS and Ubuntu Mobile/Ubuntu for phones. The Android-based model discussed is an exemplary but not exclusive environment in which the present invention may be used.

The use of a user-definable location response tailored to the user's preferences allows for privacy and security when using a wireless device. Use of an intelligent agent application on a wireless device allows automatic, customizable, and personal control over the services provided by the wireless device and data generated by those services. Use of this agent provides local or remote control of device services and individualized limitations on user-level applications. The limitations can range from a simple prohibition on access to a service to complex access rules where individual applications and processes are granted rights based on the device's knowledge of time-of-day, current location, user settings, remotely set rules and global prohibitions.

By making the user-definable location plausible, detection of the spoofed location is averted. In cases where continuous or periodic tracking of the user is to be averted, making a series of plausible locations hides the user's location.

The foregoing is a summary and thus includes, by necessity, simplifications, generalizations and omissions of detail. Those skilled in the art will appreciate that the summary is illustrative only and is not intended to be in any way limiting.

### BRIEF DESCRIPTION OF THE DRAWING

The foregoing summary as well as the following detailed description is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 schematically depicts the functional elements of the StrongHold System in accordance with the various aspects of the invention.

FIG. 2 illustrates the operations of the StrongHold System in accordance with the various aspects of the invention.

FIG. 3 illustrates generation of a region of probable spoofed locations in accordance with the various aspects of the invention.

FIG. 4 illustrates the refinement of a spoofed location in accordance with the various aspects of the invention.

FIG. 5 depicts an exemplary method for spoofing of location and collateral information in accordance with the various aspects of the invention.

FIG. 6 Depicts refinement of a current spoofed location constrained by the prior spoofed location in accordance with the various aspects of the invention.

FIG. 7 shows the operations of the watchdog application(s) in accordance with the various aspects of the invention.

### DETAILED DESCRIPTION

Illustrative embodiments of the present invention are described herein with respect to the various aspects of the invention. Wireless devices have grown in sophistication but have diverged sharply from the benign vision of a trusted personal secretary as in Arthur C. Clarke's ‘minisec’ (“Imperial Earth, 1976) or David Drake's ‘Artificial Intelligence Device (AID)’. One view of modern wireless devices states that they a tracking device for users who may want to make calls, messaging and email.

A person's location is such a fundamental and marketable piece of information. However, a number of applications that have no need for location information still request and require virtually unlimited access to a wireless device's location capabilities.

While an advancement on the location security offered by mobile operating systems such as Android, Apple's IOS, Symbian, or the Blackberry OS, was introduced in “Unauthorized Location Detection and Countermeasures”, U.S. patent application Ser. No. 12/976,908; filed Dec. 22, 2010 a more complete security offering is needed to maximize device functionality while controlling and minimizing access to all device-produced data. A user location masked by obfuscation is truly only secure when the spoofing of location is undetectable to the location recipient.

Wireless devices that can use and benefit from customizable location access security include smartphones, feature phones, netbooks, Personal Digital assistants (PDAs), tablet computers or PCs with wireless WAN or LAN capability. All are reprogrammable devices that may be updated by the wireless operator, the user, or the owner in cases of a Mobile Device Management system (MDM) controlled device. Essentially any reprogrammable, networkable computing device with remote sensing, capability including those embedded in cars, thermostats, medical devices, and household appliances could benefit from customizable location access security

The wireless device can also have multiple networking capabilities including nomadic wired tethering, Wireless Local-Area-Network (W-LAN) transceivers (e.g. IEEE802 “WiFi”), wide-area-network transceivers (IEEE 802.16/20 (WiMAN/WiMAX), cellular data transceivers, (e.g. LTE) and short-range, data-only wireless protocols such as Body-LANs, Ultra-wide-band (UWB), Bluetooth, RFID, and Near-field-communications (NFC).

While on-board location systems (e.g. Global-Navigation-Satellite-System Receivers (GNSS)) may be used to develop a location estimate, the location of a mobile device may be determined from its interaction (i.e. radio messaging) between the mobile device and the landside network (e.g. cellular system, WiMAN, WiMAX, WiFi, Bluetooth, NFC). A single site location based on the geographic location of the wireless network transmission antenna and the beacon ID (e.g. BTS ID, Cell ID, Cell/sector ID, SSID) may be developed either by the wireless device or wireless network. Use if timing information of the signal path between the wireless device and wireless device may allow enhancement of the single site location. Using several beacon identities and power levels potentially may increase accuracy over a single site location using a power-difference-of-arrival technique (e.g. PDOA or RF Fingerprinting) possibly improved with radio propagation modeling of the radio paths, or recorded calibration data.

Databases of the network(s) topology of beacon identifiers, beacon power levels, and network beacon transmitter geographical locations may be uploaded to the wireless device allowing for use of the aforementioned techniques using just the passive receiver(s) of the wireless device.

The term ‘spoofing’ is used to denote a location estimate that has been purposefully reduced in accuracy. A spoofed location can be used when an application requires access to location and cannot be simply denied access without impairing the application's functionality, regardless if the location is required by the application for its intended, advertised function(s).

An application's access to current and historical location information may be allowed or spoofed. A spoofed location may be dithered, that is precise location estimates may be randomly (or semi-randomly) reduced in accuracy using an offset. A spoofed location may be the replacement of a precise location by a default location. A default location may be static or dynamic, with a pre-programmed, or recorded series of locations used in place of actual precise locations.

Allowed location may, for a given application, vary according to user settings; for instance, access to the actual precise location may be allowed for an application during business hours, within a certain city, or not within a set area. Location, or other access to private information may also be restricted by phone state, for instance differing permissions and rules may be applied when the wireless device UI (e.g. the screen) is locked or the wireless device is in a standby mode. Additionally, if the device is locked or in a standby mode the Stronghold system may supply a message to be displayed on the screen indicating that it is in a protected mode.

Using spoofing for location access control, that is supplying an erroneous but plausible location, enforces user control over his or her actual location, supplying at need or at will the requested level of user privacy and personal security.

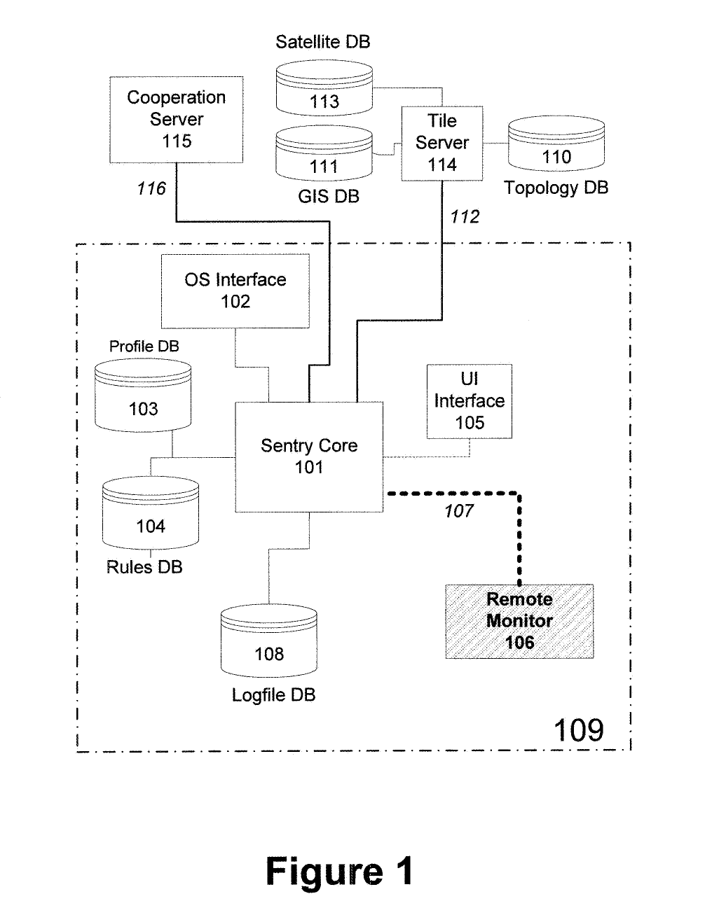

Referring now to FIG. 1, in accordance with the various aspects of the invention, a StrongHold system 109 supplies the necessary functionality for location access control. As shown in FIG. 1, the StrongHold system 109 includes a core 101, an Operating System (OS) interface 102, a profile database 103, a rules database 104, a UI interface 105, a remote interface 107 and a logfile(s) 108. In some versions of the StrongHold system, the remote interface 107 and remote monitor 106 may be deleted. In other versions of the StrongHold system the interface 105 to the device UI may be omitted. A tile Server 114 and a Cooperation Server 115 may be located in the wireless device or implemented as landside data network-based servers.

The Sentry Core 101 is the main program and manages the various subsystems. In addition to basic file control and interface traffic management, the Sentry Core 101 also includes the detection capability for secure access control and the necessary logic to implement both the actions required by the profile and rules as well as interactions with the device and OS services (e.g. requesting subsystem state information, current location or time-of-day). Logging and reporting functions to are controlled by the Sentry Core 101.

The various options for the OS interface 102 were taught in detail in the prior filing “Unauthorized Location Detection and Countermeasures”, U.S. patent application Ser. No. 12/976,908; filed Dec. 22, 2010. The OS interface 102 allows the StrongHold System's application(s) (the StrongHold System includes one or more applications used to deliver the individual access controls offered) to interface with the mobile device's OS or to mimic, override, replace or supplant and existing programmic interface (often called “API”, this is a protocol or interface used by software components, such as the operating system and an application, to communicate with each other).

The StrongHold system 109, in accordance with the various aspects of the invention, includes two primary databases for access control enforcement; the Profile Database 103 and the rules database 104 in the current implementation. The profile database 103 includes the prohibitions and restrictions for each individual application. The Profile Database 103 includes application identifiers and actions for each access by the listed applications.

The rules database 104 includes the conditional access parameters for applications (e.g. time-of-day, current location). The rules database 104 also includes the verification routines to detect activation/deactivation sequences unique to malware attacks. The Rules Database 104, in accordance with the various aspects of the invention, includes the logic and settings to implement the actions required by the Profile as well as actions pre-set to preserve program integrity. Both databases can be updated via the UI interface 105 or the Remote Monitor 106 (via the wired or wireless link 107) if implemented. One deployment option for the StrongHold system is to start after installation with a default configuration prohibiting all access to secured data and services by any app and then build the profile database 103 and rules database 104 from the user's selections of access rights for each application and each secured service.

If the Remote Monitor 106 is implemented for an instance of the StrongHold System application, then a datalink 107 will be established permanently, ad Hoc, or periodically to link the Sentry Core 101 and the Remote Monitor 106 in accordance with the various aspects of the invention.

Connected over a wireless data interface 112, permanently or at need, the StrongHold system, the tile Server 114 takes an location (real or spoofed) and delivers information on geography, network beacons, and satellite broadcasts relevant to the transmitted location. The geography 111, the network(s) topology 110 and the satellite 113 databases may be implemented either as relational databases, or as look-ups to non-Stronghold resources such as commercial web-based services or governmental data servers. The satellite DB 113 may also include either received satellite broadcast data from remote sensors platforms or may contain from models to predict satellite data.

The UI interface 105 is an optional interface with the display(s), speaker(s) and tactile transducer(s) available on the mobile device for communicating with the user. The UI interface 105 allows the user to view logfiles and view and modify databased settings such as the Profile Database 103 and Rules Database 104. The UI interface 105 also allows the Sentry Core 101 to alert the user as set in the Rules Database 104.

The Remote Monitor 106 and remote interface 107 are optional components and if implemented allow off-device program control and logging and notification duplicative of the capabilities of the UI interface 105. The Remote Monitor 106 and remote interface 107 may be implemented as part of a Mobile Device Management (MDM) system.

The Cooperation Server 115 allows for multiple StrongHold enabled mobile devices to share data which is used to generate spoofed locations. Connected by a wireless data connection 116 to the StrongHold system, the wireless device may upload its actual location, satellite data and collateral beacon information to the Cooperation Server. In practice, the Cooperation Server 115 functionality may be combined with the tile server 114 and data sent from wireless devices used to populate and update the Topology 110 and Satellite 113 databases.

The logfile database 108 allows on-device storage of program status, handled access events, errors, changelogs for the Profile, Rules. The logfile DB 108 may be overwritten or deleted by the user or downloaded and deleted by the Remote Monitor 106.

### A. The Intelligent Agent

The StrongHold System 109 provides an intelligent agent which uses a rules database with triggering events, periodic scans and mobile device state awareness. The Stronghold System's intelligent agent app works within a pre-set rule set. It manages the information to the mobile device by preventing access to system resources (e.g. APIs) in accordance to the rules set.

For instance application access may be limited by area (geophysical, arbitrary polygon, geopolitical/legal boundary), it may be limited by time-of-day, it may be limited by the identity of the requesting application, it may be limited by source of request or type (periodic/scheduled/triggered/immediate)) of request.

The user may select the parameters for location spoofing to include spoofing boundaries, geographical or address preferences, and/or preferred area concentration(s).

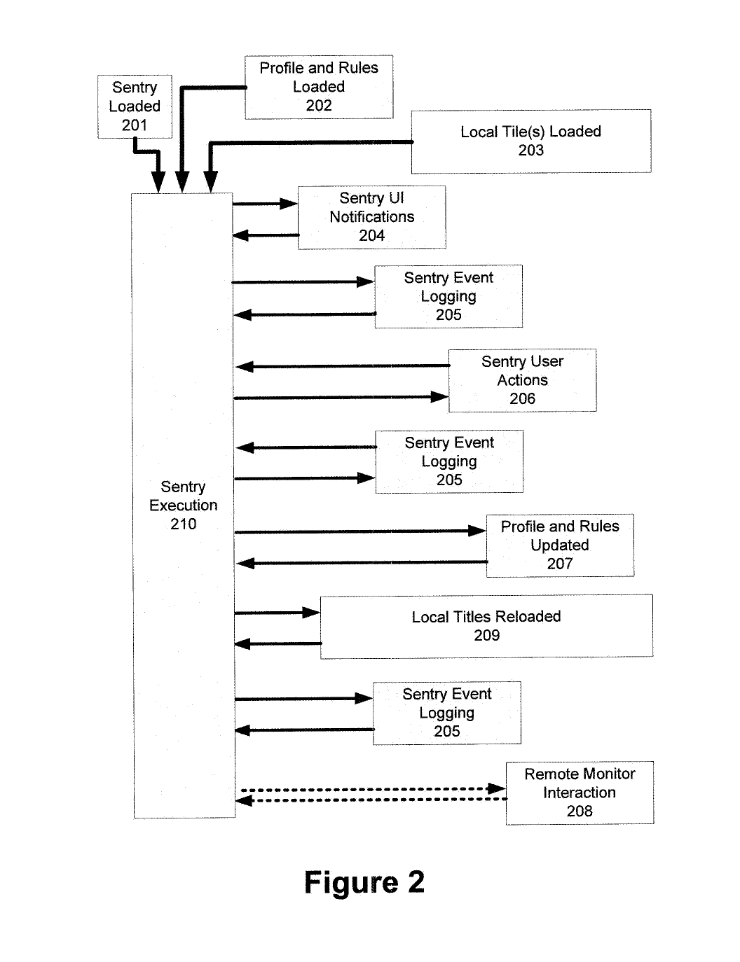

Referring now to FIG. 2, a flow of the process of the operation of the StrongHold system 109 is shown in accordance with the aspects of the invention. The Sentry program is loaded on the device at step 201 and the Initial Profile and Rules set loaded at step 202. The profiles and rules may be loaded from local storage or uploaded from a networked server. After the mobile develops a first actual location and an initial spoofed location, the local tile(s) associated with the spoofed location are loaded at step 203. The tile server remains available to the StrongHold system throughout operation so for instance, network data and geographical information is available for generation of the spoofed location. The Sentry program executes 210, providing access security to personal information and device-based services. At some time during execution, a controlled event occurs, the Sentry Program then uses the UI interface to notify the user at step 204 and logs the event at step 205. The user responds to the notification at step 206 and selects an action (e.g. always block this application from the camera during working hours and never notify). The sentry program executes (step 203) by writing the user selection (step 205) and the resulting access control to the logfile (step 205). The sentry program executes (step 203) and updates the profile and rules databases (step 207) with the user selected actions. When a new spoofed location is selected, an update of Tiles is requested by the StrongHold program and delivered (step 209). The successful database update is then logged 205 and the Sentry Program continues to execute 203.

Optionally, in accordance with the various aspects of the invention, the remote monitor in this example is set to receive a periodic (e.g. daily) update 208 of the logfile contents and then the Sentry Program continues to execute 203.

### B. Development of a Spoofed Location

When spoofing a location, making the location appear to be plausible allows for the spoofing to be undetected. An undetectable, low accuracy location assures both user privacy and unimpeded operation of the location requesting application (in cases where the location requesting application does not need the location in its operations)

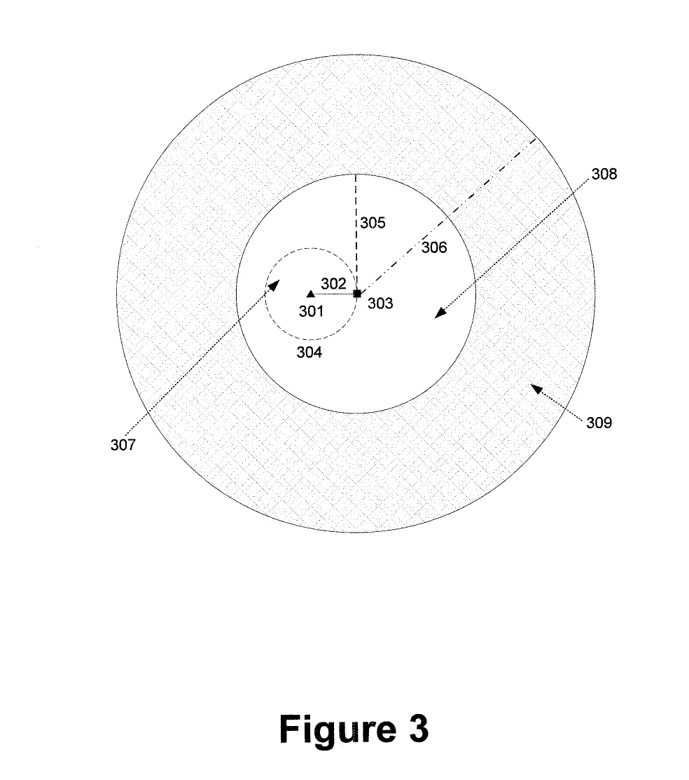

Referring now to FIG. 3, an example of the creation of a plausible spoofed location is shown in accordance with the various aspects of the invention. Since the Stronghold system has access to the actual location estimation 301, a set of rules may be constructed as to avoid reporting of that location. In this example, a first random offset 302 has been applied to the actual location estimation 301 to produce an offset centerpoint 303. The total exclusion area 307 is formed around the actual location 301. No spoofed location will ever be reported within the boundary line 304 that captures the total exclusion area 307.

A second offset 305 and a third 306 offset is then applied to the centerpoint 303, which is the endpoint of the first random offset 302, to generate a set-aside area 308 and an area of spoofing (AOS) 309. In this example, the AOS 309 is a region of probability overlaid on the geographic region using a uniform random distribution, but other non-uniform probability distributions may be used.

Whatever the probability formula used, the spoofed location will almost always appear in the AOS 309, very infrequently (only in fast moving scenarios) in the set-aside area 308 and never the area of total exclusion 307.

Use of this complex structure to guarantees that the spoofed location never impinges on the user-set area of total exclusion 307 and that use of histograms over multiple spoofed locations can never be averaged to yield the actual location but rather can never yield a location estimate closer than the centerpoint 303.

### C. Refinement of the Spoofed Location

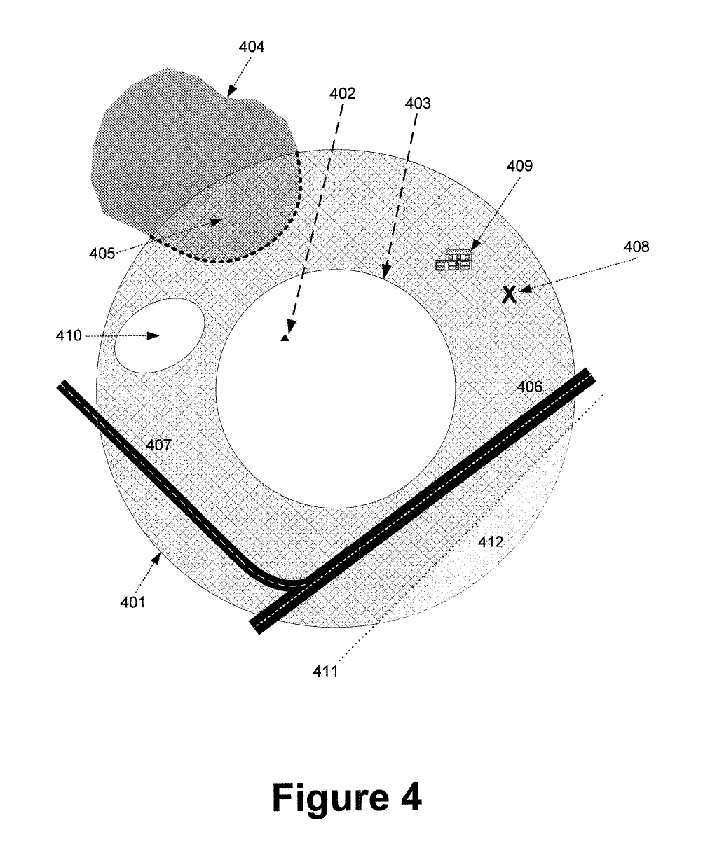

Once an initial spoofed location is generated (via the method shown in FIG. 3, or by any other method) it can be refined into a plausible location. A plausible location is a spoofed location that cannot be differentiated from an actual location by analysis of the delivered location and/or collateral information associated the delivered location. FIG. 4 details various refinements to the spoofed location to increase the plausibility of the delivered location.

### FIG. 4

Using the method detailed in FIG. 3, a region of probability 401 is established, all spoofed locations will be generated within this region 401. The actual location 402 is shown in the exclusion area 403 where no spoofed location will be generated. Note that the procedure detailed in FIG. 3 is only one of many ways to generate the region of probability.

To make the spoofed location more plausible, additional geographic areas within the region of probability may be removed. For instance, inaccessible areas such as where a body of water 404 overlaps 405 with the region of probability 401 may be deleted from consideration (or severely reduced in probability density). Other inaccessible areas may include wilderness areas, farm fields, marshes, swamps, tundra, ice caps, military bases, restricted lands or waters, missile ranges, bombing ranges, or restricted areas associated with railways, airfields, demilitarized zones, or international borders.

Certain geographic areas or features within the region of probability 401 may be increased in probability density. For example locations associated with a highway 406 could be made more likely by increasing the probability density over the area of the highway 406. Correspondingly, smaller roads 407 could receive a lesser probability density. Real-time data, such as traffic density could be used in real-time to adjust the probability density associated with any roads 406 407 within the area of probability 401.

A spoofed location 408 near an address 409 may be adjusted (“snapped”) to that address, or in cases of undesirable activities recorded for that address 409, snapped away from that address 409. One possible user preference is all (or none) spoofed locations correspond to an address. Addresses information may be supplied on building use and building type when available.

The probability density of areas with the region of probability 401 may be increased or decreased based on population density. The probability density may be adjusted to favor parks, public areas, publicly accessible buildings. The probability density may also be adjusted by land use or zoning (e.g. commercial, residential). The probability density may be adjusted by data such as crime statistics.

The user may constrain location to within a town, city, county, state, province or other political or jurisdictional area. As an example, the region of probability for a spoofed location is limited by a city limit 411, making the region of probability over the border 411 out-of-bounds for a spoofed location.

Time of day may also be used in refining an initial spoofed location. The probability density of areas, addresses, and features within the region of probability 401 may be increased or decreased to account for population density at different times of the day. Use of the calendar in computing the probability density within the region of probability 401 may also be accomplished to produce a more plausible location.

User defined areas 410, for instance the users home, office, or normal travel route may also be excluded from the region of probability and therefore never appear as a spoofed location.

As an alternative to the region of probability approach, spoofed location may also include pre-planned (and pre-scheduled) user defined locations. Spoofed locations may be drawn from a previous time interval for the same user, or several differing user's actual locations may be recorded with collateral information and then exchanged to generate spoofed locations for each.

### D. Device Produced Collateral Information

A wireless device may generate collateral information associated with a location estimate. For instance currently a wireless device may use on-board sensors to produce a satellite-based location (e.g. GPS location) while at the same time, collecting broadcast information from local cellular base stations, wireless LAN (e.g. WiFi) Access Points, television broadcasts, and local beacons (e.g. Bluetooth).

Misreporting of satellite information to generate a plausible spoofed location can be difficult. The simple replacement of the actual location with a spoofed location will typically not produce a credible set of satellite data transmitted by the satellite(s) or produced from the receiver of the satellite broadcast radio signal. Use of random satellite data results in a low plausibility spoofed location. Use of satellite data from a prior location estimate also results in a low plausibility spoofed location. Use of prior data with random or fixed offsets results in a higher plausibility spoofed location. Note that in each of the above spoofing scenarios, the clock provided by each active satellite will have to be updated either using fresh satellite data, the clock of the wireless device or a terrestrial network provided clock.

One method of returning a plausible satellite derived location (e.g. A GPS fix) would be to generate a spoofed location and then generate a set of satellite data valid for the spoofed location. Networked satellite receivers at known locations (e.g. at receivers at airports, differential-GPS transmissions, pseudo-lite transmissions, land-based stations and signal repeaters) may be used to acquire satellite broadcast data and signal information especially if located near the spoofed location.

Another method of returning a plausible satellite derived location (e.g. A GPS fix) would be to exchange actual locations and received radio data (satellite and terrestrial beacon) with other StrongHold equipped phone(s).

Yet another method of satellite navigation spoofing to simply not return a location estimate at all. StrongHold may be set to return no location, but satellite data for only 1-3 satellites as received, StrongHold may be set to return no location with no satellite data but rather return collateral information from other receivers that may be used by an application provider to calculate a location estimate from the collateral information.

If the region of probability constructed within the boundaries set by the user is small enough, the actual location may simply be offset within the satellite receiver's reported error margin, especially in cases where the error margin is larger or inflated by the StrongHold system.

Whatever the method of generating spoofed Satellite-broadcast derived location, the collateral information will also be spoofed. Collateral information is used here to describe any data collected from or about terrestrial beacons received by the wireless device's sensors other than the navigation satellite receiver.

While randomized values for the broadcaster identifiers (e.g. Cell-ID, Service set identification (SSID), TV station) and broadcast signal characteristics (e.g. received signal strength, timing offset, center frequency, neighbor list(s)) may be used, increased plausibility can be achieved by supplying calculated estimates based on databased information associated with the geographic area covered by the user-established spoofing offsets)

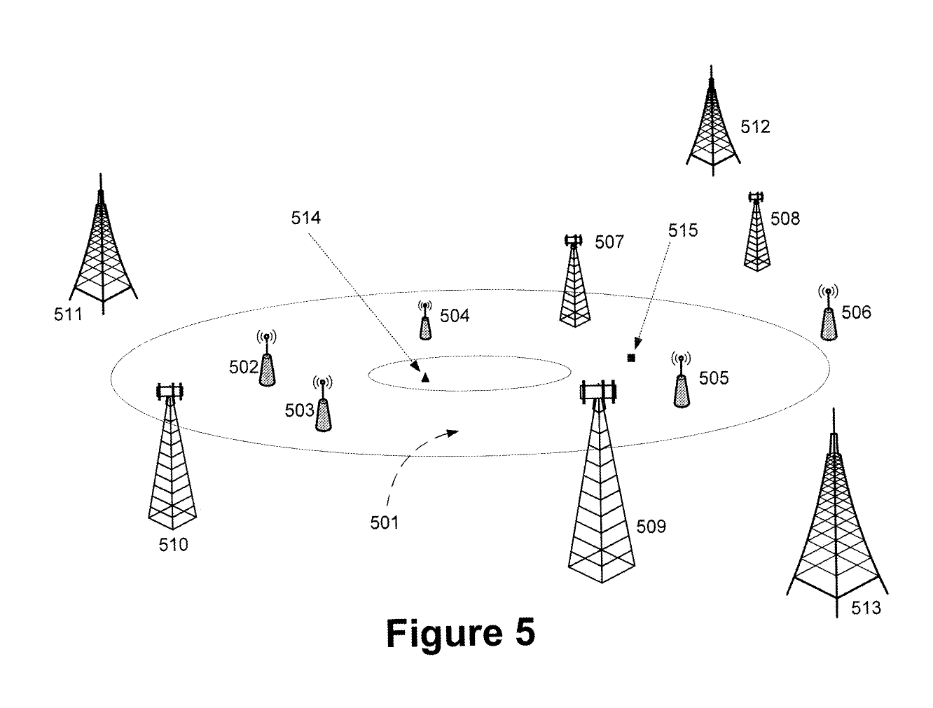

### FIG. 5

FIG. 5 depicts an exemplary method for spoofing of location and collateral information. Establishing a region of probability 501 (e.g. using the method described in FIG. 3), the StrongHold system uploads to the device information on the broadcasts associated with the geographic area overlaying and surrounding the region of probability 501. In this example, the broadcasts include those from access points 502 503 504 505 506, cellular base stations 507 508 509 510 and TV transmitters 511 512 513.

The StrongHold system using the wireless device's receivers, situated at the actual location of the wireless device 514 collects the collateral information from the nearby broadcasters. Generating a spoofed location 515, the StrongHold system then calculates estimates for the signal characteristics (power, timing, SNR) for each of the nearest predicted broadcasters at the spoofed location using databased information and the received broadcasts. In cases where no common broadcasters are in the collected and predicted broadcasters, only databased information may be used.

The generated broadcast information is compared to the collected broadcast information to assure differing values. The spoofed location may be delivered with the spoofed collateral information or the spoofed collateral information may be delivered alone.

### E. Creation of a Series of Plausible Locations

Once a location is available for analysis of the subsequent locations becomes possible. In increase the plausibility of spoofed location knowledge of the prior location can be used to create the subsequent spoofed location. This operation is then repeated for each later spoofed location, building on the previous spoofed location.

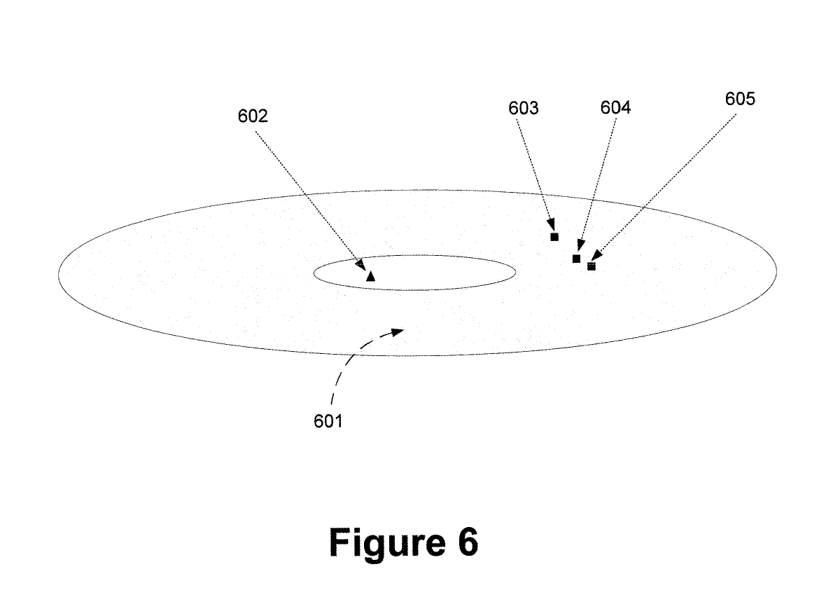

### FIG. 6

FIG. 6 depicts the creation of a series of locations in a manner that uses plausible spoofed locations and dataset rules to increase the plausibility of the entire set of locations. Using a probability region 601 (as created as in FIG. 3 as an example) and a static actual location 602, a first refined spoofed location is created 603. The subsequent spoofed location is constrained by the reported location, speed and heading of the prior location estimate. Additional constraints on the selection of a subsequent spoofed location can include data from the Geographic Information Server (GIS) on road speeds and traffic conditions if the first actual location was reported on a road surface.

If the actual location changes between location estimates\and if the change in actual location remains in the exclusion zone 606, the current probability map can be reused. If the change in actual location moves current the actual location outside the exclusion zone 606, the probability region will be recalculated before a new spoofed location can be produced.

### F. Testing of Location Access

With location being such a private and marketable item, attacks on the StrongHold system are expected. Detection of a successful attack and the resulting unmasking of the user's location is paramount.

Since the StrongHold system has access to both the actual location and the spoofed location, delivery of both locations to a set of watchdog applications loaded on the wireless device may be accomplished. The watchdog application(s) are independent of the StrongHold system and are designed to appear to be innocuous 3^{rd} party applications.

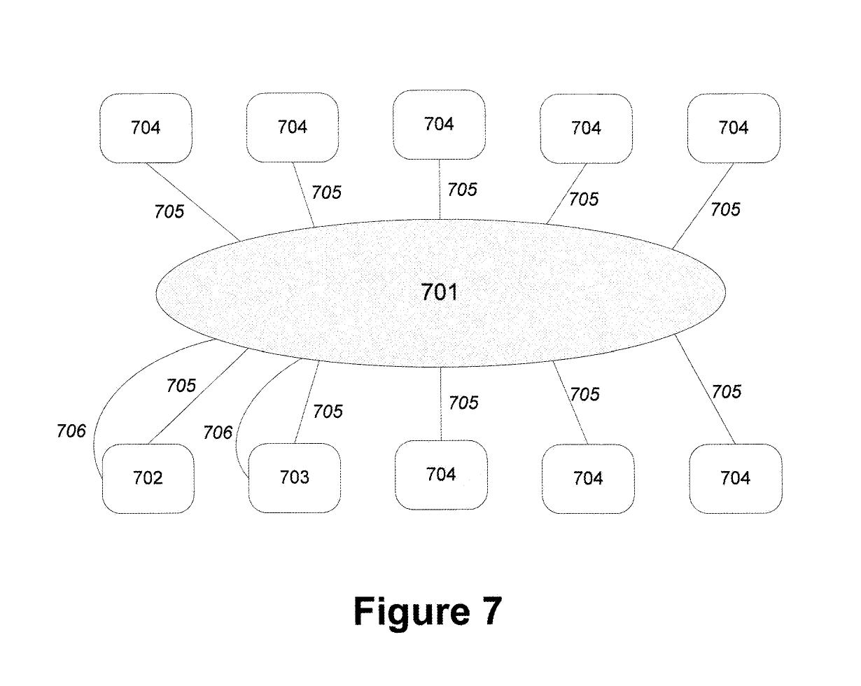

### FIG. 7

As shown in FIG. 7, in a functional Stronghold equipped device, the spoofed location is periodically delivered to each location requesting application 704 and each watchdog application 702 703 over the defined programmatic interface 705. In this example implementation, a separate watchdog exists for each type of spoofing (e.g. fixed, dithered, denied). After delivery of the spoofed location(s), a second delivery to each watchdog, this time of the actual location, is performed over a second interface 706 allowing each watchdog to compare spoofed versus actual to confirm operation of the Stronghold location access control is still active.

If the first and/or second location is not delivered, or the delivered location data does not match the expected results, the user of the wireless device is alarmed by the watchdog application(s) 702 703. In cases where a remote monitor is equipped, the watchdog applications 702 703 use the wireless link to inform the remote monitor of the situation. Use of a periodic heartbeat between the remote monitor and Stronghold system application may also be used for integrity assurance.

The true scope the present invention is not limited to the presently preferred embodiments disclosed herein and indeed could be applied to any reprogrammable remote sensing or other computing device that creates, saves and transmits information that a user or owner could consider sensitive. For example, the foregoing disclosure of a presently preferred embodiment of the StrongHold System uses explanatory terms, such as mobile device, wireless device and the like, which should not be construed so as to limit the scope of protection of the following claims, or to otherwise imply that the inventive aspects of the StrongHold System are limited to the particular methods and apparatus disclosed. Moreover, as will be understood by those skilled in the art, many of the inventive aspects disclosed herein are based on software applications and operating systems running on generic hardware processing platforms. These functional entities are, in essence, programmable data collection, analysis, and storage devices that could take a variety of forms without departing from the inventive concepts disclosed herein. Given the rapidly declining cost and power usage of processors, multi-core processors and other processing hardware, it is easily possible, for example, to combine the remote monitor with the tile Server and the Cooperation server without changing the inventive operation of the StrongHold System. In many cases, the place of implementation (i.e., the functional element) described herein is merely a designer's preference and not a hard requirement. Accordingly, except as they may be expressly so limited, the scope of protection of the following claims is not intended to be limited to the specific embodiments described above.

It is noted that, as used in this description, the singular forms “a,” “an” and “the” include plural referents unless the context clearly dictates otherwise. Reference throughout this specification to “one aspect,” “another aspect,” “one embodiment,” “an embodiment,” “certain embodiment,” or similar language means that a particular aspect, feature, structure, or characteristic described in connection with the embodiment is included in at least one embodiment of the present invention. Thus, appearances of the phrases “in one embodiment,” “in at least one embodiment,” “in an embodiment,” “in certain embodiments,” and similar language throughout this specification may, but do not necessarily, all refer to the same embodiment.

It will be apparent that various aspects of the present invention as related to certain embodiments may be implemented in software, hardware, application logic, or a combination of software, hardware, and application logic. The software, application logic and/or hardware may reside on a server, an electronic device, or be a service. If desired, part of the software, application logic and/or hardware may reside on an electronic device and part of the software, application logic and/or hardware may reside on a remote location, such as server.

In accordance with the teaching of the present invention and certain embodiments, a program or code may be noted as running on a computing device. A computing device is an article of manufacture. Examples of an article of manufacture include: a server, a mainframe computer, a mobile telephone, a multimedia-enabled smartphone, a tablet computer, a personal digital assistant, a personal computer, a laptop, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods. The article of manufacture (e.g., computing device) includes a non-transitory computer readable medium having a series of instructions, such as computer readable program steps encoded therein. In certain embodiments, the non-transitory computer readable medium includes one or more data repositories. The non-transitory computer readable medium includes corresponding computer readable program code and may include one or more data repositories. Processors access the computer readable program code encoded on the corresponding non-transitory computer readable mediums and execute one or more corresponding instructions.

Other hardware and software components and structures are also contemplated. Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or system in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

All statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

What is claimed is:

1. A method comprising:
accessing rules associated with control of location information transmitted from a device by an application running on the device;
applying the rules to the application to determine if spoofed location information is to be generated; and
if the spoofed location information is needed, then generating the spoofed location information using an exclusion area based on actual location of the device and the exclusion area, wherein the exclusion area defines a geographical area that is to be excluded from the spoofed location information generated.

2. The method of claim 1 wherein the step of generating the spoofed location information includes the step of selecting a first offset value that is applied to the actual location to generate the exclusion area.

3. The method of claim 2 further comprising the steps of:
selecting a second offset value;
selecting a third offset value;
applying the second offset value to a center location of the exclusion area to generate a first boundary of a spoofing area;
applying the third offset value to the center location to generate a second boundary of the spoofing area; and
selecting the spoofing location information from within the spoofing area.

4. The method of claim 1 further comprising the steps of:
comparing the spoofed location information to collateral information to determine if the spoofed location information is likely in light of the collateral information and a future spoofed location information;
if the spoofed location information is unlikely, then updating the spoofed location information.

5. The method of claim 4 further comprising the step of adding the collateral information to the spoofed location information to produce a more plausible spoofed location information.

6. The method of claim 1 further comprising the step of using a default location as the spoofed location information.

7. The method of claim 1 further comprising the steps of:
generating a plurality of spoofed location information, wherein each of the plurality of spoofed location information are separated in time and occur after the spoofed location information;
comparing each of the plurality of spoofed location information to a previous spoofed location information selected from the plurality of spoofed location information to determine if each of the plurality of spoofed location information is plausible relative to the previous spoofed location information; and
updating any of the plurality of spoofed location information if that spoofed location information selected from the plurality of spoofed location information is not plausible.

8. A device comprising at least one processor and at least one memory operably connected to the at least one processor, wherein the at least one memory includes instructions that, when executed by the processor, cause the device to:
determine if an application running on the device is requesting location information;
based on at least one rule, determine if spoofed location information is needed for the application; and
if the spoofed location information is needed, generate the spoofed location information using based on actual location of the device and an exclusion area,
wherein the exclusion area defines a geographical area that is to be excluded from the spoofed location information generated.

9. The device of claim 8 including further instructions that cause the device to:
select a first offset value; and
generate the exclusion area.

10. The device of claim 9 including further instructions that cause the device to:
select a second offset value;
apply the second offset value to a center location of the exclusion area to generate a first boundary of a spoofing area;
select a third offset value; and
apply the third offset value to the center location of the exclusion area to generate a second boundary of the spoofing area.

11. The device of claim 8 including further instructions that cause the device to select the spoofing location information outside the exclusion area and within a spoofing area.

12. The device of claim 8 including further instructions that cause the device to select a default location as the spoofed location.

13. A system for generating spoofed information, the system comprising:
a device for generating a plurality of sequential spoofed location information;
a module in communication with the device, the module provides collateral information to the device,
wherein the device generates each of the plurality of sequential spoofed location information using the collateral information such that a next spoofed location information in the plurality of sequential spoofed location information is plausible relative to a previous spoofed location information in the plurality of sequential spoofed location information.

14. The system of claim 13 wherein the module is a mobile device.

15. The system of claim 13 wherein the module is a database.

16. The system of claim 13 further comprising a server in communication with the device, wherein the server provides a second device's location information to the device and the device uses the second device's location information to generate spoofed location information for the plurality of sequential spoofed location information.

17. The system of claim 13 wherein the device includes the collateral information with each of the in the plurality of sequential spoofed location information to produce spoofed information.

18. The system of claim 13 wherein the device sends each of the plurality of sequential spoofed location information to the module and the module uses the plurality of sequential spoofed location information to generate a histogram based on the plurality of sequential spoofed location information and determine plausible collateral information that will be sent to the device.

19. The system of claim 13 further comprising a second device, the second device sends a second plurality of sequential spoofed location information to the module and the module pools the second plurality of sequential spoofed location information with the plurality of sequential spoofed location information to improve generation of the spoofed information.

20. The system of claim 13 wherein each of the plurality of sequential spoofed location information is replace with a default location information and the device receives a default collateral information from the database.
